(19) United States
(12) Patent Application Publication
(10) Pub. No.: US 2022/0188631 A1
(43) Pub. Date: Jun. 16, 2022

(54) ARTIFICIAL NEURAL NETWORK IMPLEMENTATION

(71) Applicant: Xmos Inc., Hampton, NH (US)

(72) Inventor: Laszlo Peter Kindrat, Hampton, NH (US)

(73) Assignee: Xmos Inc., Hampton, NH (US)

(21) Appl. No.: 17/123,397

(22) Filed: Dec. 16, 2020

(51) Int. Cl. G06N 3/08; G06N 3/04; G06N 20/10

(52) U.S. Cl. CPC G06N 3/08; G06N 20/10; G06N 3/04

(57) ABSTRACT

A method of implementing an artificial neural network, ANN, (100) comprises applying a splitting operation for each respective target portion (130b) of a target tensor (130a): i) determining a respective source portion (130a) of a source tensor (120a) required to produce that target portion (130b); ii) loading values from the determined source portion (130a, and not other values from the source tensor (120a), to a working memory (202a); iii) calculating the target portion (130b) using the source portion (130a) in the working memory (202a); iv) outputting the calculated target portion (130b) for storing in an output memory (202b).

### TECHNICAL FIELD

The present disclosure relates to a method of implementing an artificial neural network (ANN).

### BACKGROUND

Many systems may want to use Machine Learning techniques in order to enhance the user experience. This can be particularly true for so-called “edge” computing systems in which processing and data storage are distributed closer to the end device (e.g. thermostats, door locks, ovens, etc.). For example, a thermostat may learn when the room is normally warmed up, and pre-empt that; a door lock may learn to recognise the person in front of the door using a camera, and open the door if they are authorised; and an oven may use a radar chip to work out whether there is a child nearby, and if so lock the oven door.

One method to implement machine learning is the use of Artificial Neural Networks, or ANN. An ANN will process input data (e.g. from a sensor) through a series of layers, each layer calculating more features of the previous layer, until a final layer calculates a predicted output. The appeal of an ANN is that they are capable of learning and modelling highly complex patterns and relationships in the data, by using several layers with a potentially large number of parameters. Some parameters of an ANN (e.g. kernels to be applied to input data or data from a previous layer) are determined during a training phase, and are held constant during the inference phase.

An ANN layer may take different forms; for example, it may be a convolutional layer, where N kernels are convolved with the input data, producing N output values for each convolution. It may be a dense layer, where the inner product of all values with N kernels are calculated to produce N output values. Convolutional and dense layers are parametric, and thus need to be trained. Complex neural networks consist of multiple ANN layers stacked sequentially, the output of one layer feeding into the next. An important aspect of ANNs is the use of non-linear activation functions between layers. These non-linear functions can clamp some ranges, and amplify other ranges with constant or input-dependent gains. Other commonly used layers include maximum and average pooling, used to downsample activations and data to reduce computational complexity. The combination of parametric layers, pooling, and activation functions enables an ANN to learn data patterns that other machine learning models struggle with.

A more general way to express an ANN is through a computational graph consisting of tensors and operators. In one framework, the nodes of computational graphs are tensors and operators, with each edge connecting one tensor with one operator in a directed fashion. This way, a sequential chain of ANN layers can be thought of as a computational graph with a linear topology.

A tensor is an N-dimensional matrix. Typically, input tensors may have three dimensions for image data (height, width, and a number of channels for each pixel, e.g. red, green, blue), four dimensions for video data (time, height, width, channels), or two dimensions for audio data (time, frequency). Kernel tensors typically have one extra dimension, which is the number of kernels. For example, a convolution may be expressed as an input tensor I times a kernel K producing an output tensor O with the following dimensionalities:

O[476,636,64]=I[480,640,3]×K[64,5,5,3]

In this case, the input tensor has 640 by 480 pixels with 3 channels per pixel, there are 64 kernels to apply, each kernel is 5×5 in size, and has values for each of the 3 channels. This produces an output image of 636 by 476 pixels, each pixel now having 64 channels. The idea here is that each of these channels encodes some feature, maybe whether there was an edge in the image, or something green, etc. The ANN can learn 64 separate features. Note that in this particular example, the output image is smaller than the input image, as the 5×5 convolution can only be applied on 636 by 476 pixels; it is also possible to pad the input image (typically with zeros) and create a 640 by 480 output.

The tuple of the maximum number of elements in each dimension is called the shape of the tensor. In this particular case, the shape of I is (480, 640, 3) and the shape of K is (64, 5, 5, 3).

Tensors, when handled by a computing device, have a base type. The base type expresses the type of the value of each element in the tensor. For example, a tensor may have a base type of int8 (8-bit signed integers), float32 (32-bit floating point values), bit (1-bit values, representing +1 or −1), Booleans (True or False), etc.

An operator describes a basic operation on one or more tensors. Simple operators may be the pointwise addition of two tensors, or clamping negative values in a tensor to 0. More complex operators may be the convolution operator, a fully connected layer, or a pooling operation. An important property of operators is the receptive field of their output values. The receptive field of a particular pixel in the output data tensor expresses which portion of the input data tensor(s) is necessary for the calculation of that pixel in the output data tensor. The receptive field of a pooling operator's output is the pool size, while that of a convolution operator is the kernel size. Thus, these operators have non-complete receptive fields. In contrast, a fully connected layer's output value has a complete receptive field, since all input values are necessary to compute it.

The inferencing computation of a neural network can be expressed as a set of operators F₀ . . . F_{NUM_OPS-1}, each of which produces an output tensor given a number of input tensors:

T_{out[i]}=Fᵢ(T_{in[i][0]},T_{in[i][1]}, . . . )

The input tensors are either constant tensors (for example, a kernel with learned values), input data tensors, or activation tensors computed earlier. For example, the inputs for an operator may comprise a tensor from three operators earlier.

In any case, the network under our consideration is a feed-forward network, i.e. there are no loops in the network (it is a directed acyclic graph). This property means that following the data flow through the operators, it is possible to find an order in which to evaluate F₀ . . . F_{NUM_OPS-1} so that the input(s) required by each operator is/are computed before needed.

In addition to the data tensors, there are parameter or coefficient tensors that hold constant data during inference. For example, a coefficient tensor may be a threshold for each channel of an image (this would be a 1×1×64 tensor, in the case of a 64 deep data tensor), or it may be a series of convolutions to be calculated across the image. The latter could for example be a 128×3×3×64 tensors, i.e. a convolution 3×3 in width and height, having one value for each of the channels in the image (64), and there are 128 of those convolutions producing an output tensor with 128 channels. Usually, 2D convolution operations are where the processor spends most of its compute. For example, more than 90% of all multiply-accumulate operations in a typical image classification network can be in 2D convolution operators.

### SUMMARY

In accordance with a fist aspect disclosed herein, there is provided a computer-implemented method of implementing an artificial neural network, ANN, comprising a plurality of blocks, each block being arranged to operate on at least one input tensor to produce an output tensor to be operated on by one or more subsequent blocks of said plurality of blocks in the ANN, or to be output from the ANN, the method comprising applying a splitting operation for each respective target portion of a plurality of target portions of a target tensor, the target tensor being the output tensor of a target one of said blocks, said splitting operation comprising:

i), determining a respective source portion of a source tensor required to produce the respective target portion, the source tensor being an input tensor of a source one of said blocks;

ii) loading values from the determined respective source portion of the source tensor, and not other values from the source tensor, to a working memory;

iii) calculating the respective target portion of the target tensor using the respective source portion of the source tensor in the working memory; and

iv) outputting the calculated respective target portion of the target tensor for storing in an output memory.

The blocks may be layers of the ANN.

In an example, the plurality of target portions cover the entire target tensor.

In an example, each target portion comprises some but not all values of the target tensor.

In an example, the different target portions of the target tensor do not overlap in the target tensor.

In an example, at least the source tensor is of order two or above.

In an example, the target tensor is the output tensor of the block to which the source tensor is an input tensor.

In an example, the target tensor is the output tensor of a different one of the blocks from the block to which the source tensor is an input tensor.

In an example, the target tensor is a final result tensor of the ANN to be output from the ANN.

In an example, the source tensor is an initial tensor input to the ANN from an external location.

In an example, the method comprises determining the source portion of the source tensor comprises determining only the corners of the source portion within the source tensor, the source portion being defined as comprising all elements of the source tensor within the determined corners.

In an example, the method comprises identifying at least one of said blocks which has a memory requirement which exceeds the working memory; and wherein the target block is selected to be that block or a subsequent one of said blocks.

The memory requirement of a given block may be equal to the size of the input tensor(s) to that block plus the size of the output tensor of that block. The memory requirement may additionally comprise the size of any constant tensors used by that block. The memory requirement may additionally comprise the size of any tensors which are not operated on by that block, but are required to be kept alive for operation on by a subsequent block (a block appearing later in the ANN).

In an example, the method comprises receiving user input specifying the target block.

In an example, the method comprises identifying at least one of said blocks which has a memory requirement which exceeds the working memory; and wherein the source block is selected to be that block or a preceding one of said blocks.

In an example, the method comprises receiving user input specifying the source block.

In an example, the method comprises selecting a size of the target portion such that no memory requirement for any block between the source tensor and target tensor exceeds the size of the working memory.

In an example, the method comprises receiving user input specifying sizes of the target portions.

In an example, said loading comprises loading only values from the determined source portion of the source tensor which are not already present in the working memory.

In an example, the output memory is comprised by the working memory.

In an example, storing the calculated target portion in the working memory comprises overwriting the source portion in the working memory.

In an example, the method comprises applying the splitting operation for a first target portion using a first processor and applying the splitting operation for a second target portion using a second processor.

In an example, the method comprises the splitting operation for each of the target portion in parallel using a different respective processor.

In an example, the target portion is a hypercube with dimension equal to the dimensionality of the target tensor.

In an example, the working memory is a fast memory.

According to a second aspect disclosed herein, there is provided a computer program product comprising computer-executable code embodied on a computer-readable storage medium configured so as when executed by one or more processing units to perform a method of implementing an artificial neural network, ANN, comprising a plurality of blocks, each block being arranged to operate on at least one input tensor to produce an output tensor to be operated on by one or more subsequent blocks of said plurality of blocks in the ANN, or to be output from the ANN, the method comprising applying a splitting operation for each respective target portion of a plurality of target portions of a target tensor, the target tensor being the output tensor of one of said blocks, said splitting operation comprising:

i) determining a respective source portion of a source tensor required to produce the respective target portion, the source tensor being an input tensor of a source one of said blocks;

ii) loading values from the determined respective source portion of the source tensor, and not other values from the source tensor, to a working memory;

iii) calculating the respective target portion of the target tensor using the respective source portion of the source tensor in the working memory; and

iv) outputting the calculated respective target portion of the target tensor for storing in an output memory.

### BRIEF DESCRIPTION OF THE DRAWINGS

To assist understanding of the present disclosure and to show how embodiments may be put into effect, reference is made by way of example to the accompanying drawings in which:

FIGS. 1a and 1b show a graph representing an example ANN;

FIG. 2 illustrates schematically a very simplified example of a computer system for running an ANN;

FIG. 3 illustrates schematically an example of operator splitting;

FIG. 4 is a flow chart showing a method in accordance with an example described herein;

FIG. 5 shows a column chart representing a memory requirement for each layer in an example ANN; and

FIGS. 6a-c show schematically examples of portion overlap.

### DETAILED DESCRIPTION

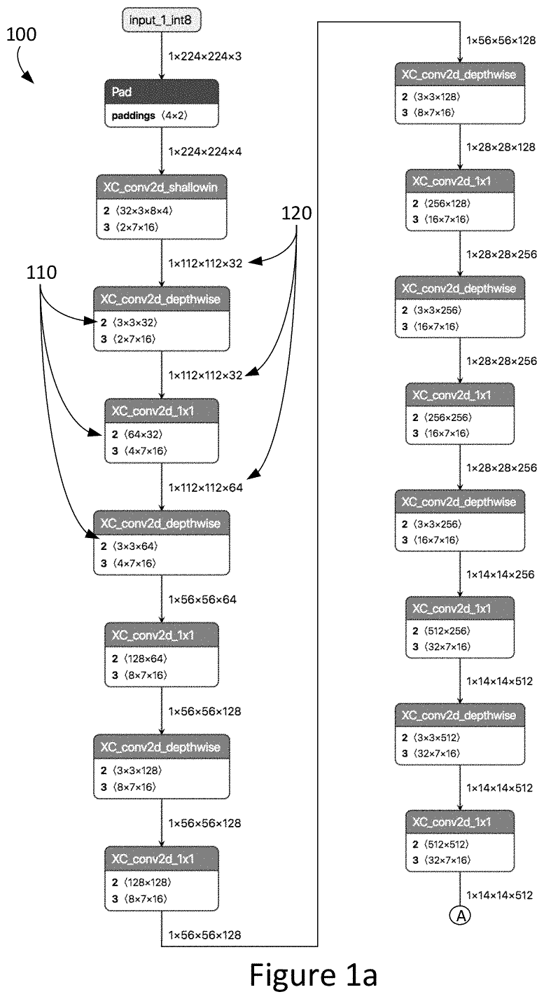

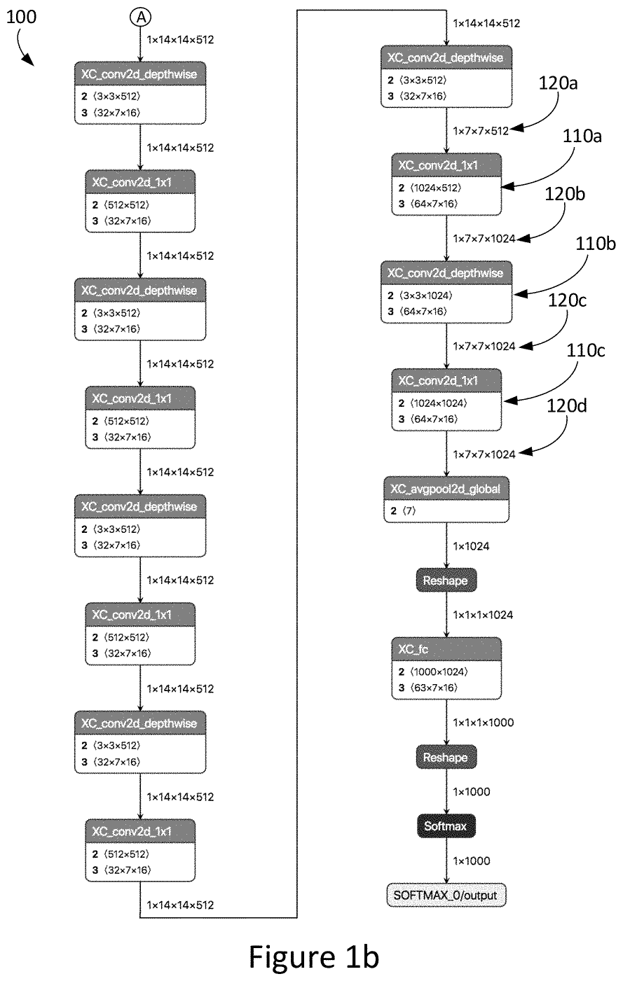

FIGS. 1a and 1b show a graph (continues over page) representing an example ANN 100. In this example representation, the edges on the graph represent data tensors 120 and the nodes represent layers 110 for operating on the data tensors 120. There may also be one or more constant tensors, but these are not visible in FIGS. 1a and 1b.

Constant tensors are the predetermined “parameters” of the ANN 100 and include, for example, a kernel to be applied by a layer 110. Constant tensors are determined during a training phase of the ANN 100, not described herein but known in the art.

Data tensors, unlike constant tensors, change depending on the data input to the ANN 100. The data tensors include the initial input tensor (e.g. the input image from external memory 300) and also tensors output by each layer 110 in operation. Unless otherwise specified herein, the term “tensor” is understood to refer to a data tensor.

Each layer 110 is an operator arranged to operate on a respective input tensor 120 to produce a respective output tensor 120. This operation may also involve one or more constant tensors (parameters).

In this example, the plurality of layers 110 are arranged in a sequence or chain, with the output tensor 120 of one layer 110 being an input tensor 120 to the next layer 110 and only that next layer 110. In more complicated examples, each layer 110 may operate on multiple input tensors 120 (e.g. output by different layers) to produce an output tensor 120. For generality, the layers 110 may be referred to as “blocks”.

It is appreciated that this is just one way to visually represent an ANN 100. For example, each layer 110 may be considered as a plurality of “nodes” each performing a part of the operation of the layer 110. That is, each layer 110 may comprise a respective plurality of nodes which together provide the function of that layer 110. The depiction in FIGS. 1a and 1b is similar, except that the functionality of all of the nodes is “wrapped up” into a single operator.

The data first input into the ANN 100 (e.g. an image, a video, an audio file, etc.) may be referred to as the “initial input tensor”. The data output by the ANN 100 may be referred to as the “final output tensor”.

In FIGS. 1a and 1b, for the purposes of explanation, a series of four tensors 120a-d and three layers 110a-c are marked. In this example, the layers 110a-c are adjacent layers of the ANN 100. Hence, the first tensor 120a is an input tensor to the first layer 120a; the second tensor 120b is the output tensor of the first layer 120a and an input tensor to the second layer 110b; the third tensor 120c is the output tensor of the second layer 120b and an input tensor to the third layer 110c; and the fourth tensor 120d is the output tensor of the third layer 110c.

It is appreciated that anything discussed in relation to these layers 110a-c, and tensors 120a-d applies similarly to any location in the ANN 100. Note that the convention used herein numbers the layers 110 from the start of the ANN 100 to the end of the ANN 100. That is, the second layer 110b appears “later” in the ANN 100 chain (further from the start and nearer the end) than the first layer 110a, and similarly for the third layer 110c, etc. Two layers 110 are “adjacent” when the output from one (the earlier layer) is an input to the other (the later layer). The term “subsequent” may be used to refer to a “later” layer (block), and the term “preceding” may be used to refer to an “earlier” layer (block).

ANNs such as ANN 100 are run on computer systems comprising at least one memory for storing values (e.g. input and output tensors, constant tensors, etc.) and at least one processor for implementing the operations of the various layers 110 on data held in the memory.

Computer system designers typically try to minimise cost and maximise functionality, typically having some small memory physically near the processor (an SRAM cache), more memory further away from the processor (DRAM), and then some persistent memory used for booting that may be read-only (e.g. Flash). As will be discussed later herein, however, this can raise specific problems for ANNs, particularly with regard to memory allocation.

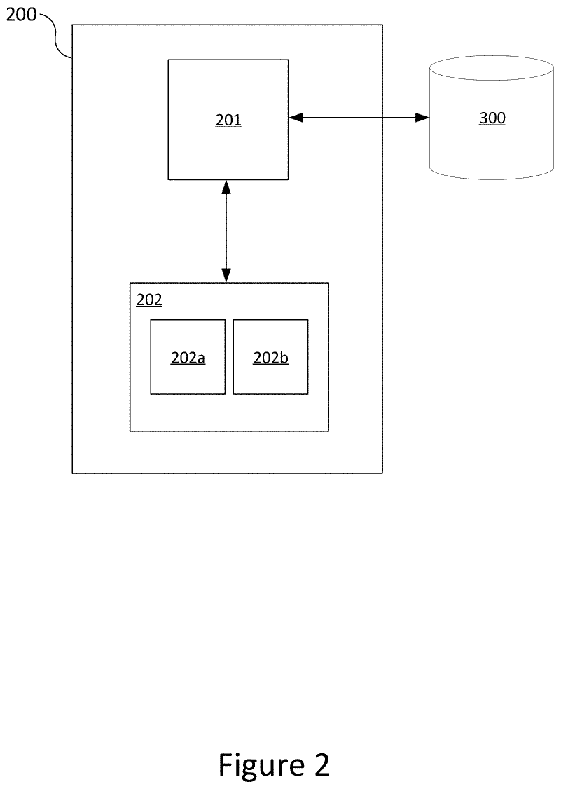

FIG. 2 illustrates schematically a very simplified example of a computer system 200 for running an Artificial Neural Network (ANN). The computer system 200 comprises a processor 201 and a memory 202. There may be a multitude of subsystems to the memory 202. For the purposes of explanation, memory 202 in FIG. 2 comprises a working memory 202a and a read-only memory 202b.

Also shown in FIG. 2 is an external memory 300, which is operatively coupled to the processor 201. The external memory 300 may be used to store the initial input tensor (e.g. input image, video, or audio data) to the ANN 100, and to store the final output tensor from the ANN 100 following computation.

The working memory 202 is preferably a fast memory, e.g. an SRAM. However, it is not excluded that the working memory is a slow memory, e.g. a DRAM. The read-only memory 202b may be true read-only or may be a memory with a limited write speed (e.g. EEPROM, Flash, etc.). Fast memories are typically expensive. Slow memories are typically cheap (cheaper than fast memories).

In operation, the processor 201 operates on different input tensors, including data input tensors and constant input tensors. The data tensors and constant tensors (parameters of the ANN 100) may be stored in different memories. In particular, the data tensors may be stored in a “tensor arena” in working memory 202a as required. Constant tensors may be held in a “tensor constant pool” e.g. in read-only memory 202b, although it is not excluded that they are stored in working memory 202a, either in a designated section of the tensor arena or in a separate constant pool. Without loss of generality, from now on we shall assume that the constant pool is not part of the arena.

The tensor arena is allocated so that at any point during the execution it can accommodate tensors 120 that are “in scope”, i.e. tensors which a) have already been output by a previous layer 110 (or are an input of the graph); and b) will need to be used by a subsequent layer 110 (or are an output of the graph). Thus, the tensor arena can reuse the memory space allocated for tensors 120 that are no longer needed. Methods of allocating the tensor arena within working memory 202a (i.e. to allow sufficient memory space to hold the required tensors throughout the course of implementing the ANN 100) are known in the art. The present invention can allow for a smaller tensor arena than would otherwise have been thought possible.

In operation, the ANN 100 is executed one operator at a time, keeping tensors 120 in working memory 202a that are required by a subsequent layer 110 (“live” tensors), and discarding tensors 120 that will no longer be required (“dead” tensors). In the simplest case, where the graph is a simple linear progression of layers 110 (as in FIGS. 1a and 1b), the input and output tensor of the currently executed layer 110 is always kept in working memory 202a. Where the graph is not linear, other tensors have to be additionally kept in working memory 202a. This all contributes to the memory requirement of a particular layer 110.

Specifically, the memory requirement of a given layer comprises at least a contribution from the input tensor(s) to that layer and the output tensor of that layer (i.e. the amount of memory required to hold the input(s) and output. When constant tensors are also held in working memory 202a, the memory requirement additionally comprises the size of any constant tensors used by that layer (all constant tensors used by the model). When the ANN 100 is not a simple linear progression of layers, the memory requirement additionally comprises the size of any tensors which are not operated on by the layer in question, but are required to be kept alive for operation on by a later layer.

One issue which can arise is that the memory requirement, at a given point in time (i.e. a given point in the execution of the ANN 100), may be too large to be held in working memory 202a. This occurs when there exists a point in the execution plan (i.e. the sequence of layers 110) where the currently live tensors 120 occupy more space than available in working memory 202a. There are three possible scenarios which would result in this:

1. The inputs and output of the layer 110 (operator) being executed dominate the memory requirement (e.g. because there are no other data tensors in scope), and cannot fit in working memory;

2. The layer's inputs and outputs occupy little space, but a large amount of working memory is occupied by tensors computed earlier that need to be kept alive for later operations; or

3. A mixture of the above two.

A conventional strategy for reducing the amount of data which is required to be held in working memory 202a relates to convolution layers. Specifically, the strategy is to stride the convolution filter (kernel) by more than one pixel in the input tensor at a time, e.g. only convolving with every other row and column of the image. This implements essentially a spatial down-sampling. Often, subsequent convolution layers work on smaller images with more channels, converting and extracting information in the spatial domain into features in parts of the image. Notable counter examples are image segmentation (where the output is the same resolution as the input), super-resolution network (where the very purpose of the network is up-sampling), as well as certain stages of common image classification models where channel counts are sometimes “blown up” and then reduced by subsequent convolutions in order to allow expressing complex non-linear relations.

Examples described herein provide “operator splitting” methods for directly reducing the memory footprint over one or more layers 110, i.e. directly reducing the amount of working memory 202a required to get from one tensor to another in the ANN 100 (which could be, but are not necessarily, the initial input tensor and final output tensor of the ANN 100). Using operator splitting, the later tensor is computed “piece-by-piece”. After the one or more layers 110 (potentially the whole ANN 100) is executed, the entire later tensor can be calculated and intact. This has the following advantages:

1) Reducing the transport of data tensors between external memory and working memory. For example, tensors that are not necessary for the current operator but need to be kept alive for a later one, are commonly written to external memory and read back later when needed. Operator splitting can avoid the need for transport of these tensors.

2) Reducing the amount of external memory needed, in some cases making it unnecessary to have an external memory (in either case thereby reducing the system cost).

Operator splitting, in accordance with examples described herein, enables large networks to be run utilizing an external memory in a more controlled and efficient fashion, and even to be run without external memory (e.g. a Low Power Double Data Rate, LPDDR memory), relying just on working memory (e.g. flash). As mentioned, this can greatly reduce manufacturing costs.

In other examples, the ANN 100 maybe run on a multi-tile processor system. In such cases, many working (fast) memories may be used. For example, each tile may implement, using its own working memory, different portion(s) of the operator splitting. That is, the calculating of the output tensor on a portion-by-portion bases can be performed in parallel, greatly decreasing executing time.

Using the methods described herein, the input and output tensors of the split region (or of the whole model for that matter) don't need to be in external memory 300. In fact, the idea of the splitting is that they are kept in working memory 202a while the split region is calculated (this may come with some costs for storing inputs and outputs, but has a big advantage in terms of only storing parts of the intermediate layers). In particular, this means that a slow memory may not be required, reducing manufacturing costs.

As will be described in more detail below, operator splitting involves cutting parts of the computational graph along spatial dimensions of the data flow, i.e. splitting tensors 120 into portions and executing at least part of the ANN 100 on a portion-by-portion basis. Operators that have a non-complete receptive field can be split into two (or more) operators with nearly identical hyperparameters, each acting on a subimage (portion) of the original input, and producing a subimage (portion) of the output. The full output can then be constructed from these subimages.

A basic property of a useful split is that the portions of the output tensor are non-overlapping. The size of the portions can be varied to meet memory requirements.

Operator splitting can be performed over the entire ANN 100 (i.e. over all layers 120) or can be performed over only a part of the ANN 100. In general terms, therefore, operator splitting can be performed between one or more “source” tensors and a “target” tensor, the source tensor and target tensor being any tensor of the ANN 100. Note that an operator may operator on multiple input tensors. For example, an operator of the ANN 100 may take two (or more) images as inputs and determine if they are from the same class, or more generally compute a (learned) similarity measure.

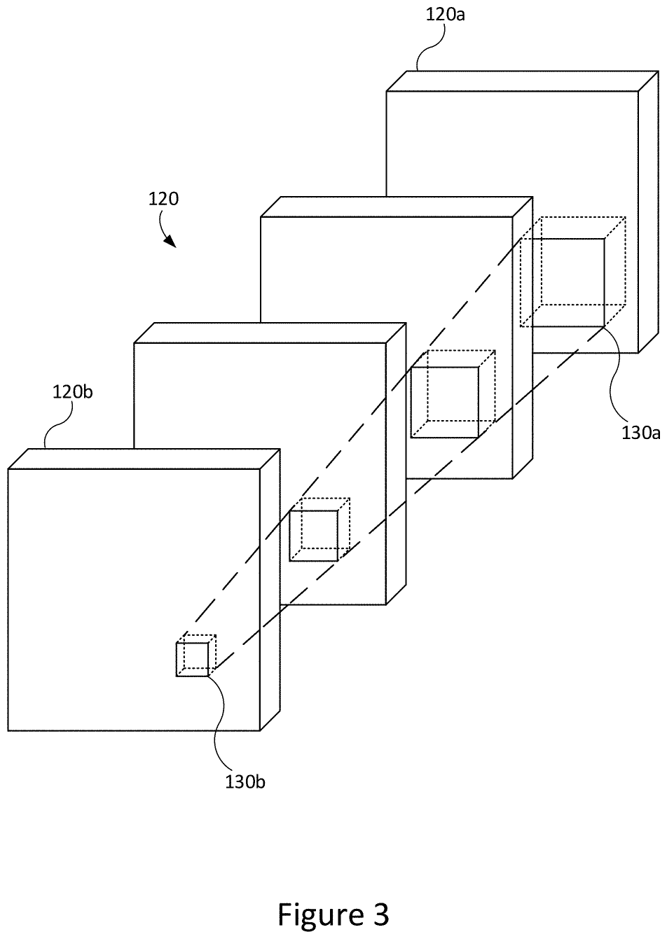

An example of operator splitting is illustrated schematically in FIG. 3. A source tensor 120a and target tensor 120b are shown, with two “intermediate” tensors 120 falling between the source tensor 120a and target tensor 120b in the ANN 100. In other examples, there may be any number of intermediate tensors, including zero (i.e. the target tensor 120b and source tensor 120a may be adjacent one another).

For the sake of clarity, the operators (layers 110) are not shown, but exist between each adjacent pair of tensors 120 in the manner discussed above. In this example, it is assumed that each layer 120 implements a 3×3 convolution. The spatial extent of each tensor 120 is not shown to scale.

A source portion 130a of the source tensor 120a is marked. Similarly, a target portion 130b of the target tensor 120b is marked. Each portion 130 is a subset of the values of the respective tensor 120. Each portion 130 may comprise a single pixel (tensor element) or may comprise plural pixels.

The source portion 130a is determined based on the target portion 130b. Specifically, the source portion 130a comprises those and only those values from the source tensor 120a which are required by the processor 201 to calculate the values in the target portion 130b. Of course, one or more layers 110 between the source tensor 120a and target tensor 120b may operate on one or more constant tensors, e.g. kernels). Therefore, calculating the target portion 130b may (and indeed usually does) require more input values than just those of the source portion 130a. However, given a particular target portion 130b, all of the values of the source portion 130a are required to calculate that target portion 130a, whereas this is not true in general of the source tensor 120a (i.e. values from the source tensor 120a which are outside the source portion 130a are not required to calculate the target portion 130b). This means, generally, that calculating the target portion 130b does not require the full source tensor 130a to be loaded to working memory 202a at once (only the source portion 130a needs to be loaded).

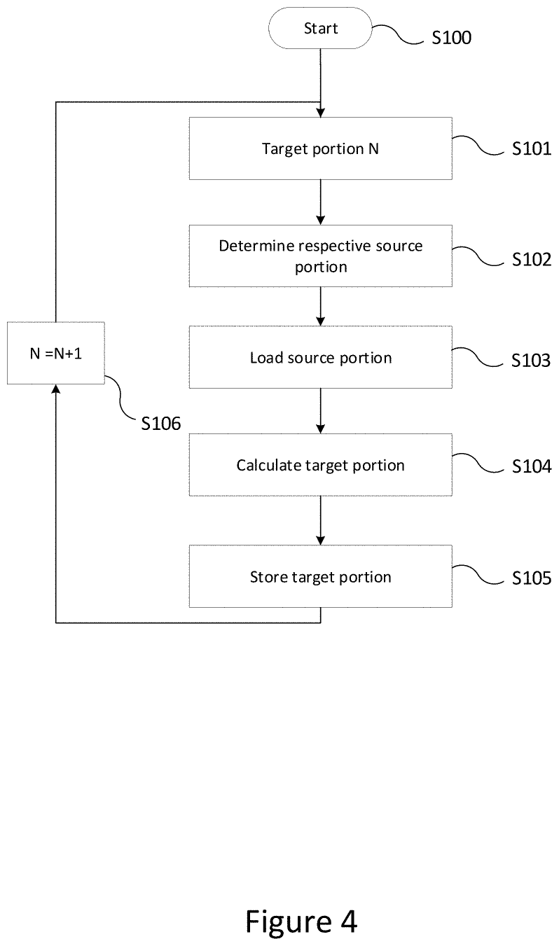

FIG. 4 is a flow diagram showing a method performed by the processor 201 in accordance with examples described herein.

The method starts at S100 by entering the loop S101-106. Each loop is performed with respect to a different target portion 130b of the target tensor 120b.

At S101, the current target portion 130b is identified. For example, the method may begin with a target portion in one corner of the target tensor 120b. The size of the target portion 130b is determined based on memory requirements, which is discussed in more detail later below.

At S102, the respective source portion 130a for the current target portion 130b is determined. This comprises, essentially, identifying the receptive field of all elements in the target portion 130b. The source portion 130a is then a union of those receptive fields. When there are plural intermediate layers 110 between the target portion 1230b and source portion 130a, the same determination is made repeatedly from layer to layer until the source tensor 130a is reached. An example algorithm for performing this step is set out later below.

At S103, the determined source portion 130a is loaded into working memory 202a where it can be operated on by the processor 201. This comprises loading at least those values of the source portion 130a which are not already present in the working memory (e.g. which were previously loaded for operation on by an earlier block). Note that there is the possibility that the whole of the source portion 130a fits in working memory, and that hence it does not need to be loaded. Similarly, both the source portion 130a and target portion 130b may fit together.

At S104, the target portion 130b is calculated using the source portion 130a in working memory 202a. As mentioned above, this may also comprise operating on one or more constant tensors (e.g. kernels) and/or operating on one or more tensors output by another layer.

At S105, the calculated target portion 130b is stored to an output memory, i.e. a memory for storing the final result of the ANN 100 computation. The output memory may be, for example, the external memory 300. In general, it is appreciated that the output memory referred to herein means any memory to which the results of the calculation applied by a block may be stored. In an example, the output memory to which the result is stored may be the working memory itself. In these cases, the source portion 130a and the target portion 130b are both stored in working memory. Even though the source portion 130a and target portion 130b may not fit together in the working memory, space within the working memory storing the source portion 130a can be “cannibalised” to store the target portion 130b; portion by portion. I.e. parts of the source portion 130a will no longer be live, these parts can be overwritten the target portion 130b.

At S106, the target portion 130b is advanced. For example, each loop, the target portion 130b may be advanced so as to not overlap with any previous target portions.

The method repeats until all of the target tensor 130b has been calculated and stored to the output memory.

Using the method above, the entire target tensor 130b can be calculated using a smaller working memory 202a, because only portions of the data tensors 120 need to be stored at any one time. Hence, the amount of data needed to be stored at any one time is not fixed solely by the size of the data tensors 120 and any ANN 100 parameters (constant tensors) like in the prior art. Rather, the amount of data needed to be stored (and therefore the required size of the working memory) depends on the size of the target portions 130b. Because the size of the target portions 130b can be chosen, this allows the operation of the ANN 100 to be adjusted to meet the memory requirements, and not the other way around.

Implementation of operator splitting, in examples, can require answers to the following questions:

1. how to determine a respective source portion 130a to load to working memory 202a based on a given target portion 130b;

2. how to select a size for the target portion 130b given a particular source layer 120a, target layer 120b, and memory requirement;

3. how to select the source layer 120a and target layer 120b over which to implement operator splitting.

These will now be addressed in turn, by way of example. Of course, in some examples, a user may provide input specifying any one or more of these parameters.

1. Determining a Respective Source Portion to Load to Working Memory Based on a Given Target Portion

An algorithm will now be described for performing step S102 from the method above, i.e. for determining the respective source portion 130a given a particular target portion 130b. This algorithm also identifies all required portions of any intermediate tensors which may be present between the target tensor 120b and source tensor 120a. It is assumed that the source tensor 120a and target tensor 120b are known (pre-defined). Example method for selecting an appropriate source tensor 120a and target tensor 120b are explained later below.

First, an “index-tuple” is defined as a value (I, (i₀, i₁, . . . )) where I is the number of a layer 110 and i₀, i₁ etc. are indices in each subsequent dimension of the data tensor input to that layer 110. There are as many i-values as there are dimensions in the tensor 120 (the number of dimensions of a tensor may generally be referred to as the “rank” of the tensor). An index-tuple uniquely identifies one value in one of the data tensors. The algorithm proceeds as follows:

For each portion of the output tensor:
Mark all data in all layers as “unneeded”. That is, for each layer k, a tensor “needed[k]” is defined that has the same shape as the data tensor for that layer. The values in all elements of all “needed” tensors are set to “False”.
Add each data element in the slice under consideration to a list “to-be-followed”. That is, an index-tuple is calculated that addresses each value in the slice under consideration. These index-tuples are added these to the list “to-be-followed”. For example, if the final layer was layer 7, that later had a 3-dimensional tensor, and the slice included elements [10 . . . 15, 15 . . . 15, 1 . . . 63] then this would add 16*16*64=16,384 tuples: (7,(0,0,0)), (7,(0,0,1)) . . . (7(0,0,63)), (7(0,1,0)), (7,(0,1,1)) . . . (7(15,15,63)).
While there are elements in the “to-be-followed” list, pick and remove an element from this list. If this element is not “needed” (that is, for index-tuple (N, index) the value of needed[N][index] is False):
   Mark this element as needed, by setting needed[N][index] to True.
   Calculate the receptive field for this element in all earlier layer(s). This is done by looking at the operator that calculates N, and seeing which inputs it uses from which previous tensors. This produces a list of index-tuples. Without loss of generality we can assume convolutions implement “valid” (i.e. no) padding, and any other padding must be implemented by an explicit padding operator preceding the convolution.
   Add all index-tuples in the computed receptive field to the “to-be-followed” list.
Record all elements that have “needed” set to true as prerequisites for this slice. That is, iterate over the list of “needed” tensors, and create an index-tuple for each True value that is found, and add this to the receptive list.

This generates for a particular target portion 130b a list of elements that are needed in all previous tensors 110 in order to compute this target portion 130b. From this, the memory requirement for each layer 110 can be determined (as the amount of memory required to hold the input portion(s) and output portion of that layer, and optionally the one or more parameters of that layer). This can be used to select an appropriate target portion size, as explained later below.

This list may be too extensive to be stored in run-time memory (e.g. working memory 202a). In examples, this can be compressed by creating only the “bounding box” for each layer 110. The bounding box describes the part of the tensor 120 over which the operator should calculate the result. In other words, a portion of a tensor (e.g. the source portion 130a of the source tensor 120a) can be specified by its corners only, rather than specifying every element contained within that portion.

A bounding box of a set of points in an N-dimensional space is defined as a tuple with N-pairs, each pair holding a minimum and a maximum value. For each point p in the set with coordinates (p₀, p₁ . . . ) and a bounding box ((mini₀, maxi₀), (mini₀, maxi₁), . . . ) the bounding box is defined so that (miniᵢ≤pᵢ≤maxᵢ). A tight bounding box is defined so that for each i there is a p such that (miniᵢ=pᵢ), and there is a p such that (pᵢ=maxᵢ).

From the set of points for a layer, the bounding box can be calculated as follows:
Create an empty bounding box B; an N-tuple ((infinity, −infinity), (infinity, −infinity), . . . ). This sets the minimum value to infinity, and the maximum value to −infinity. Appropriate highest and lowest value for a domain can be used, such as ((MAXINT, MININT), . . . ). N is the number of dimensions of the space.
For each point p in the set with index (p₀, p₁ . . . ):
   extend the bounding box minima for each dimension i to include p, and extend the bounding box maxima for each dimension to include pᵢ.
   Given a bounding box B with value ((mini₀, maxi₀), (mini₀, maxi₁), . . . ), create a new bounding box with value ((min(mini₀, p₀), max(maxi₀, p₀)), (min(mini₁, p₁), max(maxi₁, p₁)), . . . )

When the portions of the tensors are specified by bounding boxes, computing the inference (i.e. enacting the ANN) comprises iterating through the portions: for each portion iterating through all the layers 110 of the network 100, and calculating that part of the target tensor 120b that is specified by the bounding box associated with that target portion 130b. This may be expressed in pseudo-code as shown below:

For each portion of the final layer:
for each layer i . . . j
   Calculate the values in the bounding box for that layer for this portion

A simplification that can be made is to instead of calculating a precise list of element and then calculating the bounding boxes, the bounding boxes can be computed directly. This has benefits in terms of both memory requirements and speed. If the operators include only convolutions and pooling operators, the bounding boxes can be calculated algebraically. In these cases and more generally, the following example algorithm may be used:
Select a number of tensors 120 to split, say Tᵢ . . . Tⱼ.
Select how to cut up the final tensor Tⱼ.
For each portion of the final layer:
   mark all bounding boxes as empty, that is, for each dimension of the tensor, set the minimum vale of this to +infinity, and the maximum value to −infinity.
   add each data element in the portion under consideration to a list “to-be-followed”
   while there are elements that are “to-be-followed”, pick and remove an element from this list:
   if this element is outside the bounding box for this layer (in any dimension of the bounding box):
      extend the bounding box minima for each dimension to include this element, and extend the bounding box maxima for each dimension to include this element. The element has an index in each dimension used adjust the bounding box size in each dimension. For each dimension, the bounding box minimum value is set to the value of the index, if it is less than the current bounding box value. For each dimension, the bounding box maximum value is set to the value of the index, if it is greater than the current bounding box value.
      calculate the receptive field for this element in all earlier layer(s). That is, calculate the indices in each data tensor 120 that have an effect on the element.
      add all data points in the receptive field to the “to-be-followed” list.
   record the bounding box in each of the layers as prerequisites for this portion.

Note that this algorithm assumes that the source tensor 120a and the target tensor 120b are already known, and that the size of the target portion 130b is also already known.

2. Selecting a Size for the Target Portion Given a Particular Source Layer, Target Layer and Memory Requirement

An example method for determining an optimal size of the target portion 130b will now be described. In other examples, a user may specify the size of the target portion 130b to be used, e.g. by providing user input via a user interface to the computing system 200. A specific example of an algorithm for this purpose is also described (Algorithm 1).

For a given target portion 130b, having a particular size, the memory requirement of each layer 110 in the ANN 100 can be determined. In an example, the size of the target portion 130b is reduced such that the maximum memory requirement of any layer 110 in the ANN 100 does not exceed the size of the working memory 202a.

### Algorithm 1: Determine a Spatial Split.

Algorithm 1 determines a spatial split (i.e. the portions of the target tensor to use) given a particular source tensor and target tensor. Put simply, algorithm 1 attempts to use the entire target tensor and, if that fails, successively splits the target tensor into increasingly smaller portions until it succeeds. This algorithm assumes that the start and end block are known.

### Given:

the amount of available working memory, and
a start operator, and
an end operator (such that end is downstream from or equal to start).

### Returns:

True (for success) or False (for failure),
a list of non-overlapping portions (subregions) that cover the output tensor of the end operator, and
the estimated computational cost for executing the split.

### Steps:

1. If all inputs to the start operator and the output of the end operator do not together fit in memory, then return (False, None, None)
2. Initialize the output list to empty.
3. Initialize a queue for uncovered portions with the whole output tensor
4. While the queue of uncovered portions is not empty, repeat the following five steps
   a. Pop the next portion from the start of the queue of uncovered portions
   b. For this portion, trace receptive fields as described above to get input and intermediate regions, and calculate highest memory watermark for calculating through these portions.
   c. If highest watermark is below limit, then add this output portion to output list.
   d. Else if the part is larger than 1 pixel, then split the part into two approximately equal size portions, and push the two portions to the end of the uncovered portion queue
   e. Else return (False, None, None)
5. Calculate the cost for the output list by counting the number of operations performed
6. return (True, output list, cost)

There are two ways to use the above algorithm. In the first instance, it can be used assuming there is only fast RAM. This may fail if the problem is too large to run exclusively from fast RAM. It can also be used to run form a combination of fast and slow ROM. In that case, the check step 2 is performed on fast RAM, the check in step 6 checks that the calculated split fits in fast RAM.

3. Selecting the Source Layer and Target Layer Over which to Perform Operator Splitting

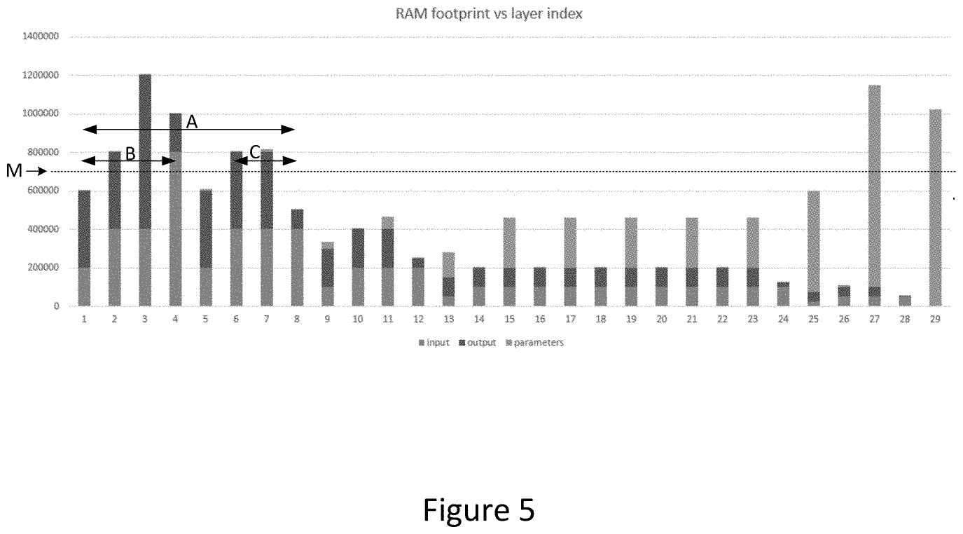

As mentioned above, Algorithm 1 requires that the source tensor 120a and target tensor 120b are already known. An example method for determining the source tensor 120a and target tensor 120b will now be described with reference to FIG. 5. In other examples, a user may specify one or more of the source tensor 120a and target tensor 120b, e.g. by providing user input via a user interface to the computing system 200. This can be advantageous in certain scenarios, since for known network architectures (e.g. FIGS. 1a and 1b) there are known good points to split the ANN 100.

FIG. 5 shows a column chart representing the memory requirement (RAM footprint) for each layer in an example ANN. The memory requirement comprises respective contributions relating to storing the input tensor(s), the output tensor, and one or more parameters (e.g. constant tensors). In reality, the parameters may be stored in a different memory, as mentioned above (e.g. they may be stored in read-only memory 202b). Therefore, the real limiting factor is the amount of memory required to store the input tensor(s) and output tensor for a given layer.

There are 29 layers in this example, arranged in a simple “chain” (similar to FIGS. 1a and 1b). The memory requirement for the input tensor for one layer is therefore equal to the memory requirement for the output tensor of the previous layer.

The size M of the working memory 202a is indicated by a horizontal dotted line. It is appreciated that this is just an example. The total memory requirement for storing the input and output tensors exceeds this size M for layers 2, 3, 4, 6, and 7, but does not exceed it for any of the other layers. Hence, it would not be possible to implement any of layers 2, 3, 4, 6 or 7 without operator splitting as provided in examples herein.

One option is to implement operator splitting over the entire range of layers which exceed the memory size M, i.e. from layer 1 to layer 8, inclusively. This is indicated by arrow A in FIG. 5. Another option is to implement operator splitting over layer 1 to layer 4 (indicated by arrow B) and then separately over layers 6 to layer 8 (indicated by arrow C).

The decision as to where and how to implement operator splitting may be made in a variety of ways. Below is described a set of algorithms which may be implemented to make this decision. For ease of explanation, these are presented as separate algorithms, but it is appreciated that in practice the steps described below may be implemented as part of one overarching method. Algorithm 3 is called to determine where to split the graphs. It calls Algorithm 2 to determine where to split a subgraph. It in turn calls Algorithm 1 (described earlier above) to determine a spatial split. An additional algorithm may be used to determine an execution schedule, such as any such algorithm known in the art and not described herein.

### Algorithm 2: Find a Splittable Subgraph Based on Guesses

Algorithm 2 determines, for a given source tensor and target tensor, whether the source tensor can be reassigned as an earlier tensor in the ANN, and/or whether the target tensor can be reassigned as a later tensor in the ANN (i.e. whether operator splitting can be implemented over a larger range or not). Memoisation, which is a technique known generally in the art, may be used around Algorithm 2 to avoid recomputing Algorithm 2 for previously computed answers. That is, the results of one instance of implementing Algorithm 2 may be stored for further use.
Given (guesses for a split):
OPstart, and
OPend (such that OPend is downstream from or equal to OPstart)

### Returns:

True (for success) or False (for failure),
a new suggestion for OPstart,
a new suggestion for OPend,
a list of portions (subregions) that cover the output tensor of the end operator, and
the estimated computational cost for executing the split.

### Steps:

1. call Algorithm1(OPstart, OPend) to calculate (success, split, cost)
2. If success then Return (success, OPstart, OPend, split, cost)
3. Initialise successS and successP to False
4. If OPend is not an output to the graph and has only one successor, then call Algorithm2(OPstart, Successor(OPend)) recursively to calculate (successS, o1S, o2S, splitS, costS)
5. If OPstart is not an input to the graph and has a predecessor, then call Algorithm2(Predecessor(OPstart), OPend) recursively to compute (successP, o1P, o2P, splitP, costP)
6. If successS and successP are both True, then execute the following step
   a. If costS<costP, then Return (successS, o1S, o2S, splitS, costS), else Return (successP, o1P, o2P, splitP, costP)
7. If successS is True then Return (successS, o1S, o2S, splitS, costS)
8. If successP is True then Return (successP, o1P, o2P, splitP, costP)
9. Return (False, OPstart, OPend, None, None)

### Algorithm 3: Operator Splitting

Algorithm 3 determines a point in the ANN which exceeds the available working memory, and finds all splits needed to meet the available memory requirement (e.g. size of working memory). This is used as the initial starting point for Algorithm 2 to improve upon.

### Given:

the amount of available working memory, and
the graph, and
the memory limits

### Returns

True (for success) or False (for failure), and
a list of operator split tuples in the form (start_op, end_op, split, cost)

### Steps:

1. Initialize empty output list
2. For each operator ‘current_op’ in the graph execute the following eight steps:
   a. If current_op fits in memory, continue step 2 with the next operator
   b. If current_op is covered by one of the tuples in the output list, continue step 2 with the next operator
   c. Let start_op=end_op=current_op
   d. call Algorithm2(start_op, end_op) to compute (success, start_op, end_op, split, cost); notice that start_op, end_op may change here
   e. If success is False, then Return (False, None)
   f. While (start_op, end_op) overlaps with one of the tuples in the output list perform the following four steps:
      i. Remove the overlapping split (start_op_other, end_op_other, split, cost) from the list
      ii. Let start_op be the earlier of start_op and start_op_other
      iii. Let end_op be the latter of end_op and end_op_other
      iv. call Algorithm2(start_op, end_op) to compute (success, start_op, end_op, split, cost); notice that start_op, end_op may change here
   g. If success is False then Return (False, None)
   h. Add (start_op, end_op, split, cost) to output list
3. Return (True, output list)

We observe that there are optimisations that can be made that perform an in-place operation, gradually replacing the input layer with the output layer. That is, as the target portion is calculated, some parts of the source portion will no longer be needed. These parts can be overwritten by said target portions (i.e. gradually replaced by calculated parts of the target portion), thereby reducing the maximum amount of memory required at any point during the calculation.

Operator splitting as described herein results in M spatial splits (i.e. M target portions and associated source portions, and potentially intermediate values). We observe that the graph can be split over N processor. That is, the M spatial splits can be implemented in sequence by a single processor, or can be provided to two or more processors to calculate at least some of the spits in parallel. If there are the same number of processors available as there are spatial splits (N=M), then all splits can be calculated simultaneously, greatly reducing computation time.

### Overheads

As mentioned above, because the source portions 130a may overlap in the source tensor 120a, there are overheads associated with re-loading values from the different source portions 130a as the ANN 100 is executed. This will now be discussed.

In many ANNs, the strategy is to, over subsequent layers of operators, reduce the size of the image and increase the depth. With reference to FIGS. 1a and 1b, for example, layer 2 may have 112×112 image with 64 channels, layer 27 may be a 7×7 image (49 pixels) with 2048 channels in each pixel. This shows that the total information in the image has shrunk from 112×112×64=802,816 values in layer 2 to 7×7×2048=100,352 values at the bottom. However, whilst the number of values has shrunk, the number of coefficients in the 2D convolution operator has gone up from 64×64=4,096 coefficients around layer 2 to 2048×2048=4,194,304 coefficients in layer 27.

This means that, in general, it is possible that for two different (non-overlapping) target portions 130b in one layer, the receptive fields of these two portions 130b, i.e. the respective source portions 130a, can still overlap (e.g. a 3×3 convolution with 1×1 stride). Because of this, a split might result in some values to be recomputed, but significantly reduces the amount of memory needed at any one time.

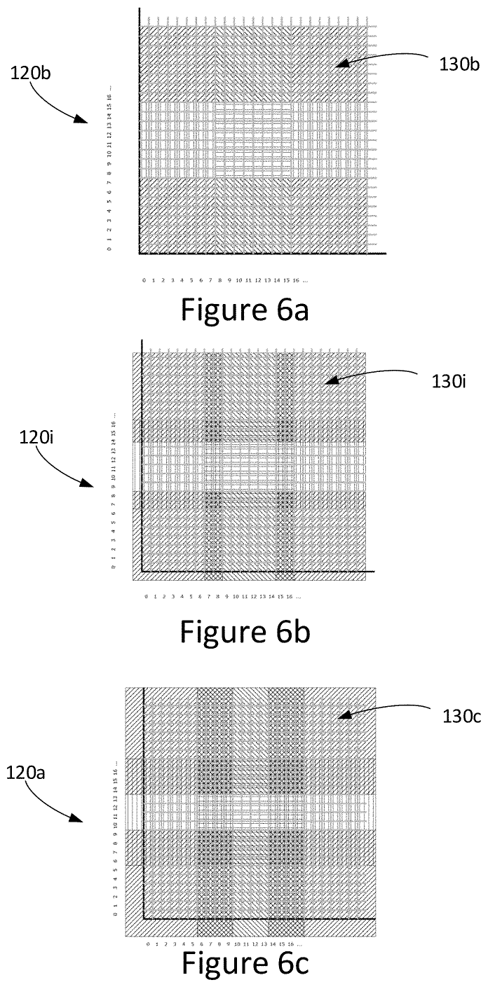

An example of portion overlap is shown in FIGS. 6a-c. FIG. 6a shows a schematic representation of the target tensor 120b. The target tensor 120b is split into nine non-overlapping portions 130b.

FIG. 6b shows a schematic representation of an intermediate tensor 120i, located earlier in the ANN 100 than the target tensor 120b. As shown in FIG. 6b, the nine respective portions 130i in the intermediate tensor 120i are no longer non-overlapping (i.e. there exists some overlap between portions 130i).

FIG. 6c shows a schematic representation of the source tensor 120c. As shown in FIG. 6c, the nine respective source portions 130a now overlap even more than they did in the intermediate tensor 120i.

It is for this reason that there is a trade-off associated with operator splitting: the memory space required is significantly reduced, but extra computing is required. Similarly, there may also be a cost in terms of execution time.

It is appreciated that the example given above is simplified. The same principles hold for more complex ANNs. For example, striding can still be applied at one or more layers to further reduce memory usage.

As a more realistic example consider the first eight layers of the ANN 100 shown in FIGS. 1a and 1b. The first layer starts with a 224×224×3 input image, and the eighth layer outputs a 28×28×128 image. That is, 150 kByte in, 100 kByte out. The largest data tensor is the input to layer 4 and measures 112×112×64 for a total of 800 kByte.

Spatial operator splitting identifies a portion in the output image of, say, 7×4 pixels; there are 28 of these target portions. In order to computer each 7×4 portion, the processor 201 is required to:

calculate a 15×9 portion out of a 56×56 image at layers 6 and 7

calculate a 17×11 portion out of a 56×56 image at layers 4 and 5

calculate a 35×23 portion out of a 112×112 image at layer 1

input a 75×51 portion into layer 1

This give the following per-layer memory requirements:

TABLE 1

| Layer | Iw | Ih | Id | Ow | Oh | Od | Input | Output | Kernel |
|---|---|---|---|---|---|---|---|---|---|
| 1 | 75 | 51 | 3 | 37 | 25 | 32 | 11,475 | 25,760 | 864 |
| 2 | 37 | 25 | 32 | 35 | 23 | 32 | 29,600 | 25,760 | 288 |
| 3 | 35 | 23 | 32 | 35 | 23 | 64 | 26,760 | 51,520 | 2,048 |
| 4 | 35 | 23 | 64 | 17 | 11 | 64 | 51,520 | 11,968 | 576 |
| 5 | 17 | 11 | 64 | 17 | 11 | 128 | 11,968 | 23,936 | 8,192 |
| 6 | 17 | 11 | 128 | 15 | 9 | 128 | 23,936 | 17,280 | 1,152 |
| 7 | 15 | 9 | 128 | 15 | 9 | 128 | 17,280 | 17,280 | 16,384 |
| 8 | 15 | 9 | 128 | 7 | 4 | 128 | 17,280 | 3,584 | 1,152 |

The means that, in each branch of the split, a single portion of the image (11 kByte) needs to be swapped in, and at the end a single portion of the output image (3.5 kByte) is stored.

This massively reduces the memory pressure, at the cost of extra multiplications, since edges of the pyramid (i.e. the overlaps) need to be recomputed. The bonus is not just a reduced bandwidth to external memory, but obviating the need for external memory in some cases.

In the example above, the largest memory pressure is in layer 3 (78 kByte). Add to this the whole input and output image (150K, 100K), for a total of 328 K, and you can see how this can all be kept in SRAM simultaneously. Even if a 4th channel is added to the input, still only a 200K input, 100K output, and a 78 kB arena for 378 kByte are required in total.

There is a computational overhead, which is as follows:

2.03× (106%) in layer 1

1.80× (80%) in layers 2 and 3

1.67× (67%) in layers 4 and 5

1.21× (21%) in layers 6 and 7)

1.00× (0%) in layer 8

This averages out as a 1.52× overhead (52%)—for being able to run this from internal memory. This overhead gets ameliorated over subsequent layers: running splitting over the next 4 layers has a 19% overhead, and after that it fits in memory. Over all layers, the increase in computational complexity is a mere 14% (1.14×).

Overhead increases the more layers are split. Overhead reduces the bigger the portion size—but memory requirements increase too. For example, it is possible to make the output patches 7×7 (there are 16 of those), and that would need a largest layer of 120 kByte, which may no longer fit with input and output image and code. It would have an overhead of 11%.

Another overhead that goes up is the loading of coefficients, because, e.g. each split may require loading all coefficients from flash memory. In the above example, the overhead if 28× for the first seven layers, but these layers account for only a small portion of the coefficients loaded. Splitting the next four layers in 2 is only 2× overhead for these, and then the remaining layers have no overhead for a total overhead of 1.22×—that is, 22% more time is spent loading parameters, loading 5.1 Mbyte vs 4.2 Mbyte without splitting.

Assuming the processor 201 can average 16 or so multiplications per thread cycle (100 MHz), and has a flash bandwidth of 50 Mbyte/s, a single thread would require 51 ms rather than an optimal 44 ms to run an inference. Two threads would take 30 ms rather than 36. Four threads would take 20 ms rather than 17. Of this, half this time is spend loading data from flash. However, as will be appreciated from the above description, this overhead may be acceptable as it enables an ANN 100 to run on a computing system 200 having a particular working memory size which would not have otherwise been sufficient to run the ANN 100.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. A computer-implemented method of implementing an artificial neural network, ANN, comprising a plurality of blocks, each block being arranged to operate on at least one input tensor to produce an output tensor to be operated on by one or more subsequent blocks of said plurality of blocks in the ANN, or to be output from the ANN, the method comprising applying a splitting operation for each respective target portion of a plurality of target portions of a target tensor, the target tensor being the output tensor of a target one of said blocks, said splitting operation comprising:
i), determining a respective source portion of a source tensor required to produce the respective target portion, the source tensor being an input tensor of a source one of said blocks;
ii) loading values from the determined respective source portion of the source tensor, and not other values from the source tensor, to a working memory;
iii) calculating the respective target portion of the target tensor using the respective source portion of the source tensor in the working memory; and
iv) outputting the calculated respective target portion of the target tensor for storing in an output memory.

2. A method according to claim 1, wherein the different target portions of the target tensor do not overlap in the target tensor.

3. A method according to claim 1, wherein at least the source tensor is of order two or above.

4. A method according to claim 1, wherein the target tensor is the output tensor of the block to which the source tensor is an input tensor.

5. A method according to claim 1, wherein the target tensor is the output tensor of a different one of the blocks from the block to which the source tensor is an input tensor.

6. A method according to claim 1, wherein the target tensor is a final result tensor of the ANN to be output from the ANN.

7. A method according to claim 1, wherein the source tensor is an initial tensor input to the ANN from an external location.

8. A method according to claim 1, comprising determining the source portion of the source tensor comprises determining only the corners of the source portion within the source tensor, the source portion being defined as comprising all elements of the source tensor within the determined corners.

9. A method according to claim 1, comprising identifying at least one of said blocks which has a memory requirement which exceeds the working memory; and wherein the target block is selected to be that block or a subsequent one of said blocks.

10. A method according to claim 1, comprising receiving user input specifying the target block.

11. A method according to claim 1, comprising identifying at least one of said blocks which has a memory requirement which exceeds the working memory; and wherein the source block is selected to be that block or a preceding one of said blocks.

12. A method according to claim 1, comprising receiving user input specifying the source block.

13. A method according to claim 1, comprising selecting a size of the target portion such that no memory requirement for any block between the source tensor and target tensor exceeds the size of the working memory.

14. A method according to claim 1, wherein said loading comprises loading only values from the determined source portion of the source tensor which are not already present in the working memory.

15. A method according to claim 1, wherein the output memory is comprised by the working memory.

16. A method according to claim 15, wherein storing the calculated target portion in the working memory comprises overwriting the source portion in the working memory.

17. A method according to claim 1 comprising applying the splitting operation for a first target portion using a first processor and applying the splitting operation for a second target portion using a second processor.

18. A method according to claim 1, comprising applying the splitting operation for each of the target portion in parallel using a different respective processor.

19. A method according to claim 1, wherein the working memory is a fast memory.

20. A computer program product comprising computer-executable code embodied on a computer-readable storage medium configured so as when executed by one or more processing units to perform a method of implementing an artificial neural network, ANN, comprising a plurality of blocks, each block being arranged to operate on at least one input tensor to produce an output tensor to be operated on by one or more subsequent blocks of said plurality of blocks later in the ANN, or to be output from the ANN, the method comprising applying a splitting operation for each respective target portion of a plurality of target portions of a target tensor, the target tensor being the output tensor of one of said blocks, said splitting operation comprising:
i) determining a respective source portion of a source tensor required to produce the respective target portion, the source tensor being an input tensor of a source one of said blocks;
ii) loading values from the determined respective source portion of the source tensor, and not other values from the source tensor, to a working memory;
iii) calculating the respective target portion of the target tensor using the respective source portion of the source tensor in the working memory; and
iv) outputting the calculated respective target portion of the target tensor for storing in an output memory.
